(19) United States
(12) Patent Application Publication
(10) Pub. No.: US 2025/0021457 A1
(43) Pub. Date: Jan. 16, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Binhui LIU, Kanagawa (JP)

(73) Assignee: FUJIFILM Business Innovation Corp., Tokyo (JP)

(21) Appl. No.: 18/434,845

(22) Filed: Feb. 7, 2024

(30) Foreign Application Priority Data
Jul. 14, 2023 (JP) 2023-115646

(51) Int. Cl. G06F 11/30; G06F 11/34

(52) U.S. Cl. CPC G06F 11/302; G06F 11/3476

(57) ABSTRACT

An information processing system includes a processor configured to, if a malfunction occurs in an apparatus, transmit, to the apparatus, inspection firmware for collecting a log for investigating the malfunction and cause the apparatus to update firmware possessed by the apparatus to the inspection firmware.

### CROSS-REFERENCE TO RELATED APPLICATIONS

This application is based on and claims priority under 35 USC 119 from Japanese Patent Application No. 2023-115646 filed Jul. 14, 2023.

### BACKGROUND

### (i) Technical Field

The present disclosure relates to an information processing system, an information processing method, and a non-transitory computer readable medium.

### (ii) Related Art

When a malfunction occurs in an apparatus, a log may be collected from the apparatus to investigate a cause of the malfunction.

Japanese Unexamined Patent Application Publication No. 2007-257085 discloses a monitoring mediation apparatus that is configured to notify a center system of type information and firmware version information of an apparatus for which the monitoring mediation apparatus is responsible and that is configured to request the center system for software bug information and bug countermeasure policy associated with the apparatus.

### SUMMARY

Firmware for investigating malfunctions in an apparatus is sometimes installed onto the apparatus in advance. For example, firmware having functions such as collecting logs for an apparatus and transmitting logs to an external apparatus may be installed onto the apparatus.

However, logs collected by the firmware installed onto the apparatus in advance are not necessarily sufficient to identify a cause of a malfunction.

Aspects of non-limiting embodiments of the present disclosure relate to collecting logs from an apparatus to identify a cause of a malfunction that occurs in the apparatus even when logs collected by the firmware installed onto the apparatus in advance are insufficient to identify the cause of the malfunction.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to, if a malfunction occurs in an apparatus, transmit, to the apparatus, inspection firmware for collecting a log for investigating the malfunction and cause the apparatus to update firmware possessed by the apparatus to the inspection firmware.

### BRIEF DESCRIPTION OF THE DRAWINGS

An exemplary embodiment of the present disclosure will be described in detail based on the following figures, wherein:

FIG. 1 is a block diagram depicting a configuration of an overall system according to the exemplary embodiment;

FIG. 2 is a block diagram depicting a hardware configuration of a managing apparatus according to the exemplary embodiment;

FIG. 3 is a block diagram depicting functions of the managing apparatus according to the exemplary embodiment;

FIG. 4 is a block diagram depicting a hardware configuration of an image forming apparatus according to the exemplary embodiment;

FIG. 5 is a block diagram depicting functions of the image forming apparatus according to the exemplary embodiment;

FIG. 6 is an illustration depicting a table for managing inspection firmware;

FIG. 7 is a flowchart depicting a process performed by the overall system;

FIG. 8 is a table depicting a relationship between the memory capacity and the quantity of debug logs;

FIG. 9 depicts a relationship between the type of debug log and whether to collect the debug log; and

FIG. 10 is a flowchart depicting a process performed by the image forming apparatus.

### DETAILED DESCRIPTION

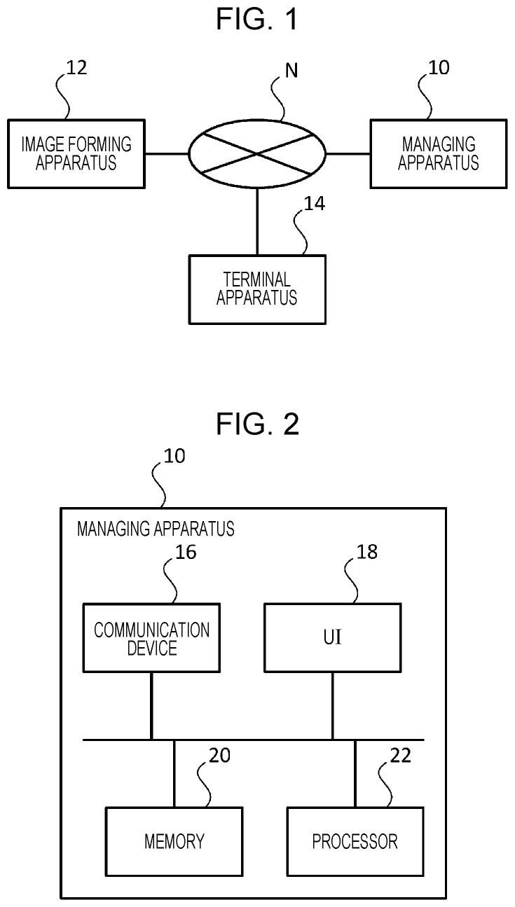

Referring to FIG. 1, a configuration of the overall system according to an exemplary embodiment will be described. FIG. 1 is a block diagram depicting an example of a configuration of the overall system according to the exemplary embodiment.

The overall system according to the exemplary embodiment includes a managing apparatus 10, an image forming apparatus 12, and a terminal apparatus 14. The overall system may include other apparatuses. The overall system may include multiple image forming apparatuses 12. The terminal apparatus 14 may be omitted from the overall system.

The managing apparatus 10, the image forming apparatus 12, and the terminal apparatus 14 are configured to communicate with other apparatuses via a communication network N. The communication network N is formed of a network such as a local area network (LAN) or the Internet. The communication network N may be formed by using wireline communication or wireless communication such as Wi-Fi (registered trademark). The managing apparatus 10, the image forming apparatus 12, and the terminal apparatus 14 may be configured to communicate with other apparatuses by using, for example, short-range wireless communication, without using the communication network N. Examples of short-range wireless communication include Bluetooth (registered trademark), radio frequency identifier (RFID), and near field communication (NFC).

The managing apparatus 10 is configured to provide inspection firmware to the image forming apparatus 12. Inspection firmware is a program for collecting logs (referred to as “debug logs”, hereinafter) for analyzing a malfunction having occurred in the image forming apparatus 12.

Examples of a malfunction as described herein include a functional deficiency, a failure, a fault, and an error that occur temporarily, intermittently, or continuously. A malfunction as described herein may be a malfunction in hardware or a malfunction in software.

For example, inspection firmware has a function of increasing the quantity of debug logs regarding a specific module (for example, a component or a device), a function of increasing the frequency of occurrence of a malfunction, or a function of identifying a cause of a malfunction in the background. Naturally, these functions are mentioned only for illustration purposes, and other functions may be implemented using inspection firmware.

The managing apparatus 10 is configured to receive a debug log transmitted from the image forming apparatus 12. For example, inspection firmware is executed on the image forming apparatus 12, and a debug log is collected from the image forming apparatus 12. The debug log is transmitted from the image forming apparatus 12 to the managing apparatus 10. The managing apparatus 10 is configured to collect a debug log from the image forming apparatus 12 in this way. The managing apparatus 10 may be configured to collect a debug log from each of the multiple image forming apparatuses 12.

A debug log is information used to analyze a malfunction having occurred in the image forming apparatus 12, and this information indicates a history of, for example, operations, processes, and manipulation performed on the image forming apparatus 12. For example, the debug log is provided to a developer, a technical support, and other people who are involved, and the malfunction is analyzed.

The image forming apparatus 12 has at least one of a printing function, a scanning function, a copying function, and a facsimile function. Any method to perform a function such as printing or scanning may be used. For example, an electrophotographic method, an inkjet method, a thermal method, or a thermal transfer method is used as the printing method.

Examples of the terminal apparatus 14 include a personal computer (abbreviated to “PC”, hereinafter), a tablet PC, a smartphone, and a cellular phone. For example, the terminal apparatus 14 is used by a person such as a developer or a maintenance operator. A person such as a developer or a maintenance operator may use the terminal apparatus 14 to develop inspection firmware. The inspection firmware may be transmitted to the managing apparatus 10 via the communication network N and may be saved onto the managing apparatus 10.

Referring to FIG. 2, a hardware configuration of the managing apparatus 10 will be described. FIG. 2 is a block diagram depicting an example of the hardware configuration of the managing apparatus 10.

The managing apparatus 10 includes a communication device 16, a UI 18, a memory 20, and a processor 22.

The communication device 16 includes one or more communication interfaces including a communication chip, a communication circuit, and other components and has a function of transmitting information to other apparatuses and a function of receiving information from other apparatuses. The communication device 16 may have a wireless communication function, such as short-range wireless communication or Wi-Fi, or may have a wireline communication function.

The UI 18 is a user interface and includes a display and an input device. Examples of the display include a liquid crystal display and an electroluminescent (EL) display. Examples of the input device include a keyboard, a mouse, and an input key or an operation panel. The UI 18 may be a UI such as a touch panel (for example, an operation panel), which combines a display and an input device.

The memory 20 is a device having one or more memory regions configured to store data. Examples of the memory 20 include a hard disk drive (HDD), a solid-state drive (SSD), various kinds of memories (for example, a random-access memory (RAM), a dynamic RAM (DRAM), a non-volatile RAM (NVRAM), and a read-only memory (ROM)), other storage devices (for example, an optical disc), and a combination of the above.

The processor 22 is configured to perform various processes and control the operation of each unit of the managing apparatus 10.

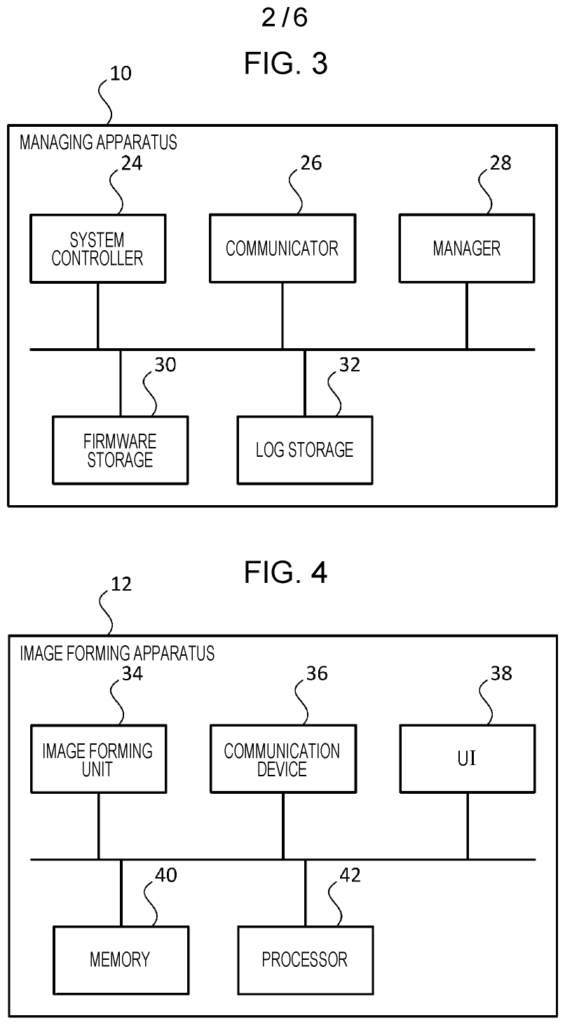

Referring to FIG. 3, functions of the managing apparatus 10 will be described. FIG. 3 is a block diagram depicting an example of the functions of the managing apparatus 10.

The managing apparatus 10 includes a system controller 24, a communicator 26, a manager 28, a firmware storage 30, and a log storage 32.

The system controller 24 is configured to control the managing apparatus 10. The system controller 24 is implemented using the processor 22.

The communicator 26 has a function of transmitting information to other apparatuses and a function of receiving information from other apparatuses. The communicator 26 is implemented using the communication device 16.

The manager 28 is configured to manage the state of the image forming apparatus 12. For example, the manager 28 is configured to detect a malfunction having occurred in the image forming apparatus 12. The manager 28 is also configured to manage inspection firmware stored in the image forming apparatus 12. If the managing apparatus 10 is configured to manage multiple image forming apparatuses 12, the manager 28 individually manages the state of each of the image forming apparatuses 12. The manager 28 is implemented using the processor 22.

The firmware storage 30 is configured to store multiple different pieces of inspection firmware. Each piece of inspection firmware is created in advance and is stored in the firmware storage 30. The firmware storage 30 is implemented using the memory 20.

The log storage 32 is configured to store a log transmitted from the image forming apparatus 12 to the managing apparatus 10. Examples of a log include a debug log and a system log. For example, inspection firmware is executed on the image forming apparatus 12 to collect a debug log, and the debug log is transmitted from the image forming apparatus 12 to the managing apparatus 10 and is saved onto the log storage 32. A system log is information indicating a history of operation of the image forming apparatus 12. For example, a system log includes a log for the operating system (OS) installed onto the image forming apparatus 12 and information regarding a screen displayed when the latest operation is performed. The log storage 32 is configured to store a system log when the system log is transmitted from the image forming apparatus 12 to the managing apparatus 10. The log storage 32 is implemented using the memory 20.

Referring to FIG. 4, a hardware configuration of the image forming apparatus 12 will be described. FIG. 4 is a block diagram depicting an example of the hardware configuration of the image forming apparatus 12.

The image forming apparatus 12 includes an image forming unit 34, a communication device 36, a UI 38, a memory 40, and a processor 42. Examples of the image forming apparatus 12 include a printer, a scanner, a copying machine, a facsimile, and a multifunction peripheral (an apparatus having functions of multiple devices such as a printer, a scanner, and a copying machine).

The image forming unit 34 has at least one of a printing function, a scanning function, a copying function, and a facsimile function. The image forming unit 34 is configured to execute the printing function to print an image representing an object such as a document onto a recording medium such as a sheet of paper. The image forming unit 34 is configured to execute the scanning function to read an image on a document and generate data representing the image. The image forming unit 34 is configured to execute the copying function to read an image on a document and print the image on the recording medium. The image forming unit 34 is configured to execute the facsimile function to use facsimile communication to transmit an image to other apparatuses and receive an image from other apparatuses.

The communication device 36 includes one or more communication interfaces including a communication chip, a communication circuit, and other components and has a function of transmitting information to other apparatuses and a function of receiving information from other apparatuses. The communication device 36 may have a wireless communication function, such as short-range wireless communication or Wi-Fi, or may have a wireline communication function.

The UI 38 is a user interface and includes a display and an input device. Examples of the display include a liquid crystal display and an electroluminescent (EL) display. Examples of the input device include a keyboard, a mouse, and an input key or an operation panel. The UI 38 may be a UI such as a touch panel (for example, an operation panel), which combines a display and an input device.

The memory 40 is a device having one or more memory regions configured to store data. Examples of the memory 40 include an HDD, an SSD, various kinds of memories (for example, a RAM, a DRAM, an NVRAM, and a ROM), other storage devices (for example, an optical disc), and a combination of the above.

The processor 42 is configured to perform various processes and control the operation of each unit of the image forming apparatus 12.

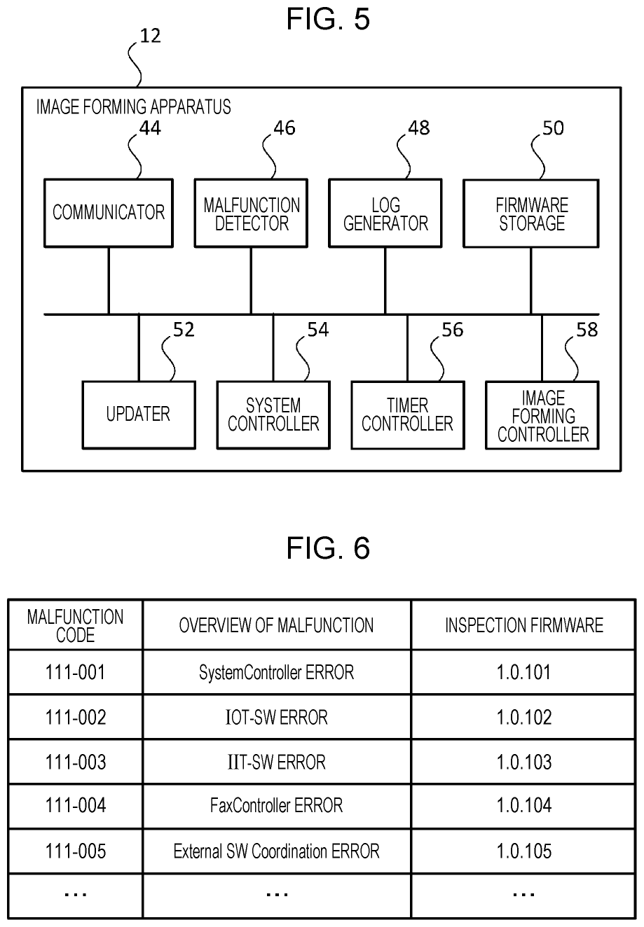

Referring to FIG. 5, functions of the image forming apparatus 12 will be described. FIG. 5 is a block diagram depicting an example of the functions of the image forming apparatus 12.

The image forming apparatus 12 includes a communicator 44, a malfunction detector 46, a log generator 48, a firmware storage 50, an updater 52, a system controller 54, a timer controller 56, and an image forming controller 58.

The communicator 44 has a function of transmitting information to other apparatuses and a function of receiving information from other apparatuses. The communicator 44 is implemented using the communication device 36.

The malfunction detector 46 is configured to detect a malfunction having occurred in the image forming apparatus 12. For example, the malfunction detector 46 is configured to detect a malfunction having occurred in the image forming unit 34 (for example, a malfunction regarding the printing function or the scanning function), a malfunction having occurred in the communication device 36 (for example, a communication fault), a malfunction having occurred in the UI 38, and a malfunction having occurred in the memory 40. The malfunction detector 46 is implemented using the processor 42.

The log generator 48 is configured to generate a log such as a debug log or a system log. For example, in response to detection of a malfunction by the malfunction detector 46, the log generator 48 executes inspection firmware to generate a debug log. The communicator 44 transmits the debug log to the managing apparatus 10. The communicator 44 may transmit the debug log and the system log to the managing apparatus 10. The log generator 48 is implemented using the processor 42.

The firmware storage 50 is configured to store inspection firmware. For example, the firmware storage 50 is configured to store inspection firmware transmitted from the managing apparatus 10. The firmware storage 50 may be configured to store default inspection firmware in advance. The firmware storage 50 may be configured to store in advance, for example, at the time of manufacture or shipment of the image forming apparatus 12, default inspection firmware created in advance. The firmware storage 50 is implemented using the memory 40.

The updater 52 is configured to update inspection firmware stored in the firmware storage 50. For example, when inspection firmware is transmitted from the managing apparatus 10 to the image forming apparatus 12, the updater 52 receives and saves the inspection firmware onto the firmware storage 50, updating the inspection firmware stored in the firmware storage 50. For example, the updater 52 is configured to update the inspection firmware by overwriting the inspection firmware stored in the firmware storage 50 with inspection firmware transmitted from the managing apparatus 10. The updater 52 may be configured to update the inspection firmware by replacing the inspection firmware stored in the firmware storage 50 with inspection firmware transmitted from the managing apparatus 10. The updater 52 may be configured to update the inspection firmware by deleting the inspection firmware stored in the firmware storage 50 and saving onto the firmware storage 50 inspection firmware transmitted from the managing apparatus 10. The updater 52 is implemented using the processor 42.

For example, if default inspection firmware is stored in the firmware storage 50 in advance, in response to the transmission of inspection firmware from the managing apparatus 10 to the image forming apparatus 12, the updater 52 updates the default inspection firmware stored in the firmware storage 50 to the inspection firmware transmitted from the managing apparatus 10.

If inspection firmware that is not default inspection firmware is stored in the firmware storage 50, in response to the transmission of inspection firmware from the managing apparatus 10 to the image forming apparatus 12, the updater 52 updates the inspection firmware stored in the firmware storage 50 to the inspection firmware transmitted from the managing apparatus 10.

Inspection firmware managed by the managing apparatus 10 at least has a function (that is, a default function) possessed by the default inspection firmware. In other words, inspection firmware managed by the managing apparatus 10 has the default function and an additional function that is not the default function. Accordingly, even after the inspection firmware is updated in the image forming apparatus 12, the default function is performed, and further, the additional function is also performed. Consequently, a debug log collected by the execution of the default inspection firmware as well as a debug log collected by the execution of the additional function is collected.

The system controller 54 is configured to control the image forming apparatus 12. The system controller 54 is implemented using the processor 42.

The timer controller 56 has a timer function and is configured to measure time and identify the time that a process such as a job was performed. The timer controller 56 is implemented using the processor 42.

The image forming controller 58 is configured to control operation of the image forming unit 34. The image forming controller 58 is configured to control, for example, printing, scanning, copying, or facsimile. The image forming controller 58 is implemented using the processor 42.

In addition to the functions described above, the image forming apparatus 12 may have a function of transmitting image data created by scanning to an external apparatus (for example, a terminal apparatus, such as a PC, and a server).

Referring to FIG. 6, specific examples of inspection firmware will be described. FIG. 6 is an illustration depicting a table for managing inspection firmware.

The table for managing inspection firmware is a table for managing multiple pieces of inspection firmware stored in the managing apparatus 10 and is stored in the memory 20 in the managing apparatus 10 in advance. The memory 20 stores in advance each piece of inspection firmware registered in this management table.

For example, in the table for managing inspection firmware, for each malfunction, a malfunction code as identifying information, information indicating an overview of the malfunction, and identifying information denoting inspection firmware are associated with each other in advance.

The malfunction code is an example of identifying information for identifying a malfunction. The information indicating an overview of a malfunction provides information indicating an overview of a malfunction that may occur in the image forming apparatus 12. Examples of the identifying information denoting inspection firmware include the version of the inspection firmware.

For example, the malfunction code “111-001” provides information for identifying a malfunction indicated by the term “System Controller Error”. The inspection firmware “1.0.101” is a program for collecting a debug log to analyze the malfunction. The string “1.0.101” may represent the version of the inspection firmware.

If the malfunction represented by the malfunction code “111-001” occurs in the image forming apparatus 12, the corresponding malfunction code “111-001” is transmitted from the image forming apparatus 12 to the managing apparatus 10. Receiving the malfunction code “111-001”, the processor 22 in the managing apparatus 10 detects that the malfunction corresponding to the malfunction code “111-001” has occurred in the image forming apparatus 12. If the inspection firmware “1.0.101” associated with the malfunction code “111-001” is not stored in the image forming apparatus 12, the processor 22 transmits the inspection firmware “1.0.101” to the image forming apparatus 12. Receiving the inspection firmware “1.0.101”, the processor 42 in the image forming apparatus 12 updates the inspection firmware stored in the memory 40 in the image forming apparatus 12 to the inspection firmware “1.0.101”.

For example, the processor 42 in the image forming apparatus 12 is configured to transmit to the managing apparatus 10, at a predetermined time or at a time specified by a user such as the administrator, the identifying information denoting the inspection firmware stored in the image forming apparatus 12. The processor 42 may be configured to, at the time that the inspection firmware stored in the image forming apparatus 12 is updated, transmit to the managing apparatus 10 the identifying information denoting the inspection firmware stored in the image forming apparatus 12 after the update (that is, the inspection firmware obtained after the update). In response to the reception of the identifying information transmitted from the image forming apparatus 12, the processor 22 in the managing apparatus 10 manages the inspection firmware stored in the image forming apparatus 12 based on the transmitted identifying information.

For example, the processor 22 in the managing apparatus 10 registers, in a table for managing image forming apparatuses, the identifying information denoting each image forming apparatus 12 and the identifying information denoting the inspection firmware stored in the image forming apparatus 12 in association with each other. The table for managing image forming apparatuses is stored in the memory 20 in the managing apparatus 10.

IoT is the abbreviation for “image output terminal”. A debug log regarding IoT represents a debug log regarding printing by a device implementing the printing function (for example, a printer). IIT is the abbreviation for “image input terminal”. A debug log regarding IIT represents a debug log regarding scanning by a device implementing the scanning function (for example, a scanner).

The inspection firmware depicted in FIG. 6 is presented only for illustrative purposes, and inspection firmware other than the inspection firmware depicted in FIG. 6 may be stored in the memory 20 in the managing apparatus 10 and may be registered in the table for managing inspection firmware.

For example, inspection firmware for investigating multiple different malfunctions may be created in advance, and the created inspection firmware may be stored in the memory 20 and may be registered in the table for managing inspection firmware. For example, inspection firmware may be created in advance that includes the inspection firmware associated with the malfunction code “111-002” and the inspection firmware associated with the malfunction code “111-003” (for example, firmware obtained by combining the two pieces of inspection firmware), and the created inspection firmware may be registered in the table for managing inspection firmware and may be stored in the memory 20.

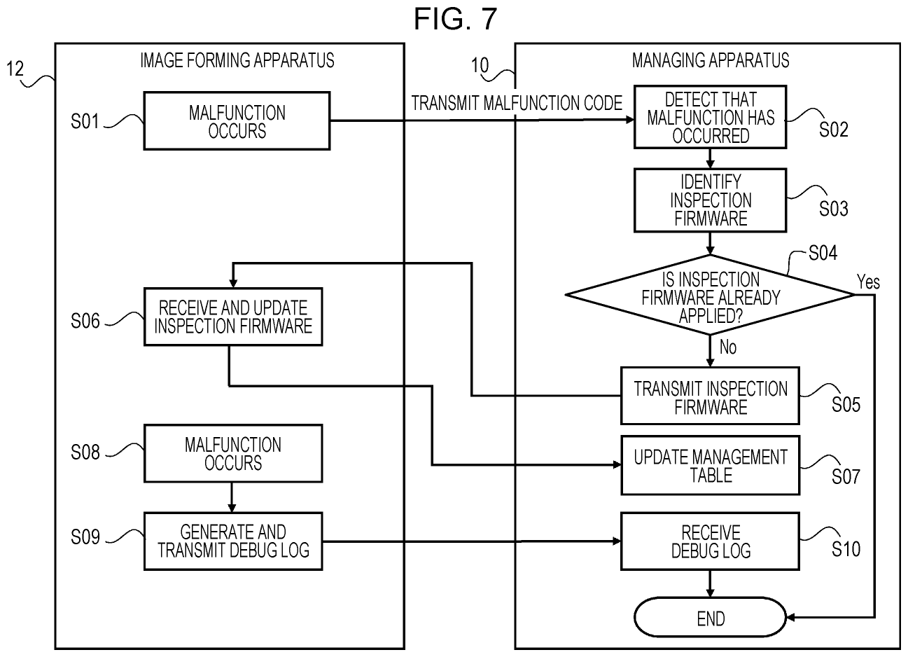

Referring to FIG. 7, a process performed by the overall system will be described. FIG. 7 is a flowchart depicting the process.

Once a malfunction occurs in the image forming apparatus 12 (S01), upon detecting the malfunction, the processor 42 in the image forming apparatus 12 transmits the malfunction code corresponding to the malfunction to the managing apparatus 10. For example, for each malfunction, information indicating an overview of the malfunction and a malfunction code are associated with each other and stored in the memory 40 in the image forming apparatus 12 in advance. The processor 42 identifies the malfunction code corresponding to the malfunction having occurred and transmits the identified malfunction code to the managing apparatus 10.

For example, the processor 42 in the image forming apparatus 12 associates the identifying information denoting the image forming apparatus 12 with the malfunction code and transmits the malfunction code associated with the identifying information denoting the image forming apparatus 12 to the managing apparatus 10. Referring to the identifying information associated with the malfunction code, the processor 22 in the managing apparatus 10 identifies the image forming apparatus 12 in which the malfunction has occurred.

Upon receiving the malfunction code transmitted from the image forming apparatus 12, the processor 22 in the managing apparatus 10 refers to the malfunction code to detect that the malfunction has occurred in the image forming apparatus 12 (S02). In addition, referring to the malfunction code, the processor 22 recognizes the overview of the malfunction having occurred in the image forming apparatus 12.

Referring to the table for managing inspection firmware (such as the management table depicted in FIG. 6), the processor 22 in the managing apparatus 10 identifies the inspection firmware associated with the malfunction code transmitted from the image forming apparatus 12 (S03).

The processor 22 in the managing apparatus 10 also determines whether the inspection firmware identified in step S03 is already stored in the image forming apparatus 12 (S04). In other words, the processor 22 determines whether the inspection firmware identified in step S03 is already applied to the image forming apparatus 12.

For example, referring to the table for managing image forming apparatuses, the processor 22 identifies the inspection firmware stored in the image forming apparatus 12 having transmitted the malfunction code. More specifically, the processor 22 uses as the search key the identifying information denoting the image forming apparatus 12 associated with the malfunction code transmitted from the image forming apparatus 12 and identifies the inspection firmware associated with the identifying information in the table for managing image forming apparatuses. The inspection firmware stored in the image forming apparatus 12 at the time of occurrence of the malfunction is identified in this way.

The processor 22 determines whether the identified inspection firmware (that is, the inspection firmware stored in the image forming apparatus 12 at the time of occurrence of the malfunction) is the inspection firmware associated with the malfunction code transmitted from the image forming apparatus 12 in the table for managing inspection firmware.

For example, the inspection firmware “1.0.101” is registered in the table for managing image forming apparatuses in association with the identifying information denoting the image forming apparatus 12 having transmitted the malfunction code. In this case, the inspection firmware stored in the image forming apparatus 12 at the time of occurrence of the malfunction is the inspection firmware “1.0.101”.

If the malfunction code transmitted from the image forming apparatus 12 is “111-001”, the inspection firmware corresponding to the malfunction code “111-001” is the inspection firmware “1.0.101” (refer to FIG. 6). In this case, the processor 22 determines that the inspection firmware corresponding to the malfunction is already applied to the image forming apparatus 12. Namely, the processor 22 determines that the inspection firmware “1.0.101” corresponding to the malfunction code “111-001” is already applied to the image forming apparatus 12.

If the malfunction code transmitted from the image forming apparatus 12 is “111-002”, the inspection firmware corresponding to the malfunction code “111-002” is the inspection firmware “1.0.102” (refer to FIG. 6). In this case, the processor 22 determines that the inspection firmware corresponding to the malfunction is not applied to the image forming apparatus 12. Namely, the processor 22 determines that the inspection firmware “1.0.102” corresponding to the malfunction code “111-002” is not applied to the image forming apparatus 12.

If the inspection firmware corresponding to the malfunction code is already applied to the image forming apparatus 12 (Yes in S04), the process ends. In this case, the processor 42 in the image forming apparatus 12 executes the inspection firmware to collect a debug log and transmits the debug log to the managing apparatus 10.

If the inspection firmware corresponding to the malfunction code is not applied to the image forming apparatus 12 (No in S04), the processor 22 in the managing apparatus 10 transmits the inspection firmware corresponding to the malfunction code to the image forming apparatus 12 (S05). For example, if the malfunction code is “111-002”, the processor 22 transmits the inspection firmware “1.0.102” to the image forming apparatus 12.

The processor 42 in the image forming apparatus 12 receives the inspection firmware transmitted from the managing apparatus 10 and updates the inspection firmware stored in the memory 40 in the image forming apparatus 12 to the received inspection firmware (S06). The inspection firmware stored in the image forming apparatus 12 is changed from the inspection firmware “1.0.101” to the inspection firmware “1.0.102” in this way. The processor 42 transmits to the managing apparatus 10 the information indicating that the inspection firmware has been updated.

Upon receiving from the image forming apparatus 12 the information indicating that the inspection firmware has been updated, the processor 22 in the managing apparatus 10 updates the table for managing image forming apparatuses (S07). More specifically, the processor 22 changes, in the table for managing image forming apparatuses, the identifying information denoting the inspection firmware associated with the identifying information denoting the image forming apparatus 12 to the identifying information denoting the updated inspection firmware. In the present example, the inspection firmware before update is the inspection firmware “1.0.101”, and the inspection firmware after update is the inspection firmware “1.0.102”. In this case, the processor 22 changes the identifying information denoting the inspection firmware associated with the identifying information denoting the image forming apparatus 12 from the inspection firmware before update, “1.0.101”, to the inspection firmware after update, “1.0.102”.

If the same malfunction as has occurred in step S01 occurs in the image forming apparatus 12 after the inspection firmware stored in the image forming apparatus 12 is updated (S08), the processor 42 in the image forming apparatus 12 executes the updated inspection firmware to generate a debug log (S09). For example, the processor 42 executes the inspection firmware after update, “1.0.102”, to generate a debug log. The processor 42 transmits the generated debug log to the managing apparatus 10 (S09).

The processor 22 in the managing apparatus 10 receives the debug log transmitted from the image forming apparatus 12 (S10). For example, the processor 22 saves the debug log onto the memory 20. If receiving a request to acquire the debug log, the processor 22 may provide the debug log to the requester in response to the request. For example, the processor 22 may transmit the debug log to an external apparatus, cause a display to present the debug log, or print the debug log.

In the following, examples will be described.

### Example 1

If the malfunction “IoT-SW error” corresponding to the malfunction code “111-002” occurs in the image forming apparatus 12, the malfunction code “111-002” is transmitted from the image forming apparatus 12 to the managing apparatus 10. Upon receiving the malfunction code “111-002”, the processor 22 in the managing apparatus 10 detects that the “IoT-SW error” has occurred in the image forming apparatus 12.

Referring to the table for managing inspection firmware, the processor 22 in the managing apparatus 10 identifies the inspection firmware “1.0.102” associated with the malfunction code “111-002”.

In addition, referring to the table for managing image forming apparatuses, the processor 22 in the managing apparatus 10 checks the inspection firmware stored in the image forming apparatus 12 in which the malfunction has occurred.

If the inspection firmware stored in the image forming apparatus 12 in which the malfunction has occurred is not the inspection firmware “1.0.102”, the processor 22 in the managing apparatus 10 transmits the inspection firmware “1.0.102” to the image forming apparatus 12.

Upon receiving the inspection firmware “1.0.102” from the managing apparatus 10, the processor 42 in the image forming apparatus 12 updates the inspection firmware stored in the image forming apparatus 12 to the inspection firmware “1.0.102”.

The inspection firmware “1.0.102” is executed on the image forming apparatus 12, and the following process is performed.

The quantity of debug logs regarding IoT collected by the execution of the inspection firmware “1.0.102” is ten times the quantity of debug logs regarding IoT collected by the execution of the inspection firmware other than the inspection firmware “1.0.102”.
The operation of an IoT-related module is constantly traced, and a debug log is created. The IoT-related module is a constituent (such as a component) of a device implementing the printing function.
The debug log includes a log regarding a finisher. A finisher is a device having functions such as stapling and folding.

The inspection firmware “1.0.102” is executed on the image forming apparatus 12. If the malfunction “IoT-SW error” corresponding to the malfunction code “111-002” occurs again, a debug log regarding IoT is collected with the above process. Since the above process is customized to IoT-related operation, a debug log collected with the above process is information useful to identify a malfunction regarding IoT.

The debug log collected by the execution of the inspection firmware “1.0.102” is transmitted from the image forming apparatus 12 to the managing apparatus 10.

If the inspection firmware stored in the image forming apparatus 12 in which the malfunction has occurred is the inspection firmware “1.0.102”, the processor 22 in the managing apparatus 10 does not transmit the inspection firmware “1.0.102” to the image forming apparatus 12.

### Example 2

If the malfunction “external SW coordination error” corresponding to the malfunction code “111-005” occurs in the image forming apparatus 12, the malfunction code “111-005” is transmitted from the image forming apparatus 12 to the managing apparatus 10. Upon receiving the malfunction code “111-005”, the processor 22 in the managing apparatus 10 detects that the “external SW coordination error” has occurred in the image forming apparatus 12.

Referring to the table for managing inspection firmware, the processor 22 in the managing apparatus 10 identifies the inspection firmware “1.0.105” associated with the malfunction code “111-005”.

In addition, referring to the table for managing image forming apparatuses, the processor 22 in the managing apparatus 10 checks the inspection firmware stored in the image forming apparatus 12 in which the malfunction has occurred.

If the inspection firmware stored in the image forming apparatus 12 in which the malfunction has occurred is not the inspection firmware “1.0.105”, the processor 22 in the managing apparatus 10 transmits the inspection firmware “1.0.105” to the image forming apparatus 12.

Upon receiving the inspection firmware “1.0.105” from the managing apparatus 10, the processor 42 in the image forming apparatus 12 updates the inspection firmware stored in the image forming apparatus 12 to the inspection firmware “1.0.105”.

The inspection firmware “1.0.105” is executed on the image forming apparatus 12, and the following process is performed.

The quantity of debug logs regarding network collected by the execution of the inspection firmware “1.0.105” is ten times the quantity of debug logs regarding network collected by the execution of the inspection firmware other than the inspection firmware “1.0.105”.
The operation of a network-related module is constantly traced, and a debug log is created. Examples of the network-related module include the communication device 36.
Communication packets are constantly collected, and the debug log includes the result of the collection of the communication packets.

The inspection firmware “1.0.105” is executed on the image forming apparatus 12. If the malfunction “external SW coordination error” corresponding to the malfunction code “111-005” occurs again, a debug log regarding network is collected with the above process. Since the above process is customized to network-related operation, a debug log collected with the above process is information useful to identify a malfunction regarding network.

The debug log collected by the execution of the inspection firmware “1.0.105” is transmitted from the image forming apparatus 12 to the managing apparatus 10.

If the inspection firmware stored in the image forming apparatus 12 in which the malfunction has occurred is the inspection firmware “1.0.105”, the processor 22 in the managing apparatus 10 does not transmit the inspection firmware “1.0.105” to the image forming apparatus 12.

In the following, modifications will be described.

### Modification 1

Inspection firmware according to Modification 1 has a function of performing a different process depending on a constituent of the image forming apparatus 12.

For example, the constituent is a storage device in the image forming apparatus 12. For example, depending on the capacity of the memory to store debug logs (referred to as the “memory for debug logs” below), the inspection firmware according to Modification 1 changes the quantity of debug logs to be collected. The memory for debug logs is included in the memory 40 in the image forming apparatus 12.

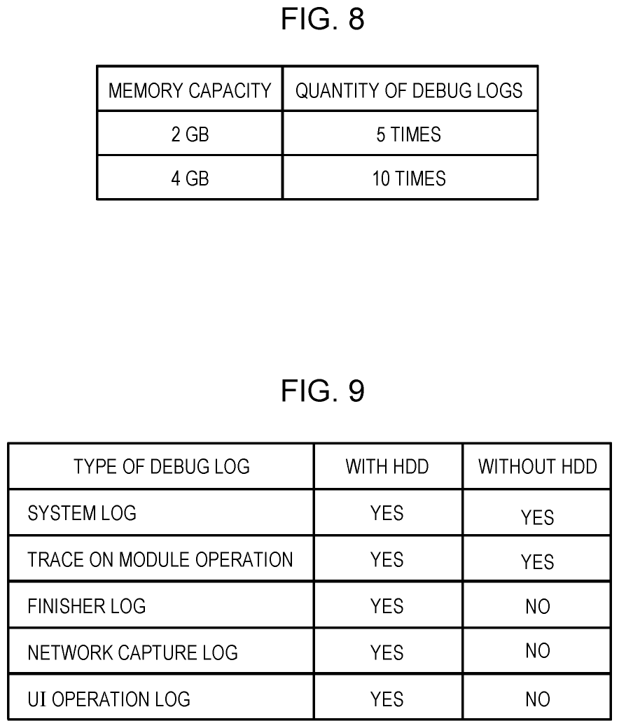

FIG. 8 depicts a relationship between the memory capacity and the quantity of debug logs. For example, information indicating the relationship between the memory capacity and the quantity of debug logs is possessed by the inspection firmware according to Modification 1. The inspection firmware according to Modification 1 is configured to collect debug logs in accordance with the information indicating the relationship.

For example, if the capacity of the memory for debug logs is 2 GB, the quantity of debug logs is 5 times the default quantity. Namely, the quantity of debug logs collected by the execution of the inspection firmware according to Modification 1 is 5 times the quantity of debug logs collected by the execution of the default inspection firmware.

If the capacity of the memory for debug logs is 4 GB, the quantity of debug logs is 10 times the default quantity. Namely, the quantity of debug logs collected by the execution of the inspection firmware according to Modification 1 is 10 times the quantity of debug logs collected by the execution of the default inspection firmware.

For example, the processor 42 in the image forming apparatus 12 executes the inspection firmware according to Modification 1 to collect debug logs, changing the quantity of debug logs depending on the capacity of the memory for debug logs included in the image forming apparatus 12.

For example, if the capacity of the memory for debug logs included in the image forming apparatus 12 is 2 GB, the processor 42 in the image forming apparatus 12 executes the inspection firmware to collect debug logs 5 times as much as the default inspection firmware collects. If the capacity of the memory for debug logs included in the image forming apparatus 12 is 4 GB, the processor 42 in the image forming apparatus 12 executes the inspection firmware to collect debug logs 10 times as much as the default inspection firmware collects. Thus, inspection firmware for each capacity of the memory for debug logs need not be created in advance. In other words, inspection firmware for 2 GB and inspection firmware for 4 GB need not be separately created, and a single piece of inspection firmware may perform collection depending on the capacity of the memory for debug logs. If the capacity of the memory for debug logs included in the image forming apparatus 12 is more than 2 GB and less than 4 GB, the processor 42 executes the inspection firmware to collect debug logs 5 times as much as the default inspection firmware collects.

### Modification 2

Inspection firmware according to Modification 2 has a function of performing a different process depending on whether the image forming apparatus 12 includes a specific constituent. For example, the specific constituent is a storage device of a specific type. For example, the storage device of the specific type is a hard disk drive.

For example, if the image forming apparatus 12 does not include a hard disk drive, the inspection firmware does not collect a debug log expected to have a relatively large size. Namely, a debug log expected to have a relatively large size is excluded from collection targets. A debug log expected to have a relatively large size is defined in advance. Information indicating such a debug log is possessed by the inspection firmware according to Modification 2. The processor 42 in the image forming apparatus 12 executes the inspection firmware according to Modification 2 to collect a debug log, excluding from collection targets a debug log indicated in the information.

FIG. 9 depicts a relationship between the type of debug log and whether to collect the debug log. Examples of a debug log depicted in FIG. 9 are a system log, a trace on module operation, a finisher log, a network capture log, and a UI operation log. A mark “YES” in FIG. 9 indicates that a debug log marked with “YES” is to be collected. A mark “NO” in FIG. 9 indicates that a debug log marked with “NO” is not to be collected.

For example, the system log and the trace on module operation are debug logs to be collected irrespective of whether the image forming apparatus 12 includes a hard disk drive (HDD). The finisher log, the network capture log, and the UI operation log are to be collected if the image forming apparatus 12 includes a hard disk drive and are not to be collected if the image forming apparatus 12 does not include a hard disk drive.

For example, information indicating the relationship depicted in FIG. 9 is possessed by the inspection firmware according to Modification 2. The processor 42 in the image forming apparatus 12 executes the inspection firmware according to Modification 2 to collect a debug log in accordance with the information.

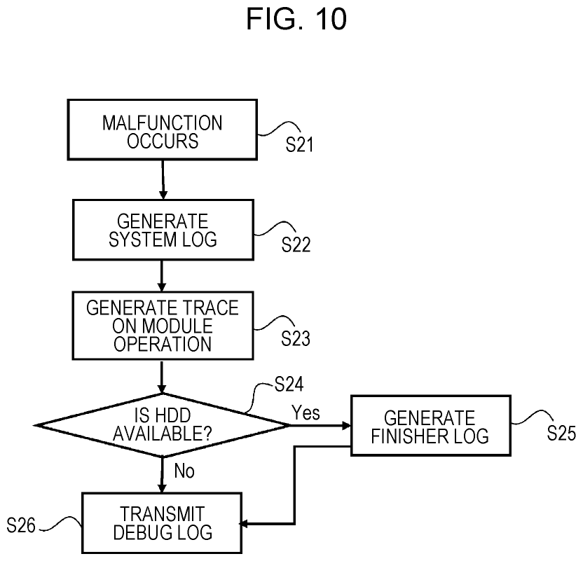

Referring to FIG. 10, a process according to Modification 2 will be described. FIG. 10 is a flowchart depicting a process according to Modification 2.

In this example, the inspection firmware according to Modification 2 is stored in the image forming apparatus 12. Namely, the default inspection firmware that had been stored in the image forming apparatus 12 is already updated to the inspection firmware according to

### Modification 2.

Once a malfunction occurs in the image forming apparatus 12 (S21), the processor 42 executes the inspection firmware according to Modification 2 to generate a system log (S22). The processor 42 also generates a trace on module operation (S23). The trace on module operation is information indicating a history of operation of a constituent of the image forming apparatus 12.

If the image forming apparatus 12 includes a hard disk drive (Yes in S24), for example, the processor 42 generates a finisher log (S25). The processor 42 transmits a debug log including a finisher log to the managing apparatus 10 (S26).

If the image forming apparatus 12 does not include a hard disk drive (No in S24), for example, the processor 42 generates a debug log that does not include a finisher log and transmits the debug log to the managing apparatus 10 (S26).

If the image forming apparatus 12 does not include a hard disk drive, a debug log needs to be saved onto a secure digital (SD) card, an embedded multimedia card (eMMC), or a similar device having a relatively small capacity. In such a case, excluding a debug log having a relatively large size from collection targets allows a debug log to be stored without causing a shortage of capacity for storing debug logs.

### Modification 3

Inspection firmware according to Modification 3 has a function of performing a different process depending on the capacity of a memory for debug logs.

For example, the inspection firmware according to Modification 3 does not collect a debug log expected to have a relatively large size based on the capacity of the memory for debug logs. Specifically, if the capacity of the memory for debug logs is less than a threshold, the inspection firmware according to Modification 3 does not collect a debug log expected to have a relatively large size. A debug log expected to have a relatively large size is defined in advance, and examples of such a debug log include a finisher log depicted in FIG. 9.

### Modification 4

Inspection firmware according to Modification 4 is configured to handle a combination of multiple different malfunctions and has a function of collecting a debug log to investigate each malfunction.

In Modification 4, in response to the occurrence of a first malfunction, the inspection firmware stored in the image forming apparatus 12 is updated to the inspection firmware corresponding to the first malfunction. Once the inspection firmware is updated, information indicating that the inspection firmware has been updated is transmitted from the image forming apparatus 12 to the managing apparatus 10. Receiving the information, the processor 22 in the managing apparatus 10 registers, in the table for managing image forming apparatuses, the identifying information denoting the image forming apparatus 12 and the identifying information denoting the inspection firmware after update in association with each other. In this case, the processor 22 registers, in the table for managing image forming apparatuses, the identifying information denoting the image forming apparatus 12 and the identifying information denoting the inspection firmware corresponding to the first malfunction in association with each other.

If a second malfunction different from the first malfunction occurs after the inspection firmware is updated in the image forming apparatus 12 described above, the malfunction code representing the second malfunction is transmitted from the image forming apparatus 12 to the managing apparatus 10. Referring to the table for managing image forming apparatuses, the processor 22 in the managing apparatus 10 confirms that the inspection firmware stored in the image forming apparatus 12 is the inspection firmware corresponding to the first malfunction. In this case, the processor 22 transmits to the image forming apparatus 12 inspection firmware for collecting a debug log for investigating the first malfunction and a debug log for investigating the second malfunction (referred to as “mixed inspection firmware” below). The processor 42 in the image forming apparatus 12 updates the inspection firmware stored in the image forming apparatus 12 (such as the inspection firmware for investigating the first malfunction) to the mixed inspection firmware. Thus, if the first malfunction occurs again after the second malfunction occurs, a debug log for investigating the first malfunction is collected. In addition, if the second malfunction occurs, a debug log for investigating the second malfunction is collected.

Some of the functions of the managing apparatus 10 may be implemented by an apparatus other than the managing apparatus 10. If some of the functions of the managing apparatus 10 are implemented by an apparatus other than the managing apparatus 10, an information processing system may be formed by the managing apparatus 10 and the apparatus other than the managing apparatus 10. In other words, the functions of the managing apparatus 10 may be implemented by a single apparatus or by an information processing system including multiple apparatuses.

The functions of the managing apparatus 10 are implemented, for example, by the cooperation between hardware and software. For example, the processor 22 in the managing apparatus 10 reads and executes programs stored in the memory, and the functions of the managing apparatus 10 are implemented. Programs are saved onto the memory by using a recording medium, such as a compact disc (CD) or a digital versatile disc (DVD), or via a communication path such as a network. Similarly, the processor 22 in the managing apparatus 10 reads and executes programs stored in the memory, and the functions of the managing apparatus 10 are implemented. Programs are saved onto the memory by using a recording medium, such as a CD or a DVD, or via a communication path such as a network.

Some of the functions of the image forming apparatus 12 may be implemented by an apparatus other than the image forming apparatus 12. If some of the functions of the image forming apparatus 12 are implemented by an apparatus other than the image forming apparatus 12, an information processing system may be formed by the image forming apparatus 12 and the apparatus other than the image forming apparatus 12. In other words, the functions of the image forming apparatus 12 may be implemented by a single apparatus or by an information processing system including multiple apparatuses.

The functions of the image forming apparatus 12 are implemented, for example, by the cooperation between hardware and software. For example, the processor 42 in the image forming apparatus 12 reads and executes programs stored in the memory, and the functions of the image forming apparatus 12 are implemented. Programs are saved onto the memory by using a recording medium, such as a CD or a DVD, or via a communication path such as a network. Similarly, the processor 42 in the image forming apparatus 12 reads and executes programs stored in the memory, and the functions of the image forming apparatus 12 are implemented. Programs are saved onto the memory by using a recording medium, such as a CD or a DVD, or via a communication path such as a network.

The managing apparatus 10 may be configured to collect a log from an apparatus other than the image forming apparatuses 12. Namely, inspection firmware may be configured to collect a log of an apparatus other than the image forming apparatuses 12.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
a processor configured to:
   if a malfunction occurs in an apparatus, transmit, to the apparatus, inspection firmware for collecting a log for investigating the malfunction and cause the apparatus to update firmware possessed by the apparatus to the inspection firmware.
      (((2)))

The information processing system according to (((1))),
wherein the processor is configured to:
   if the apparatus does not possess the inspection firmware, transmit the inspection firmware to the apparatus.
      (((3)))

The information processing system according to (((1))), further comprising:
a memory configured to:
   store a plurality of different pieces of inspection firmware in advance, wherein the processor is configured to:
   transmit to the apparatus a piece of inspection firmware associated with the malfunction out of the plurality of different pieces of inspection firmware.
      (((4)))

The information processing system according to (((1))),
wherein the processor is configured to:
   if a second malfunction different from a first malfunction occurs in the apparatus, the first malfunction being associated with the inspection firmware to which the firmware possessed by the apparatus has been updated, transmit to the apparatus inspection firmware for investigating the first malfunction and the second malfunction and cause the apparatus to update firmware possessed by the apparatus.
      (((5)))

The information processing system according to (((1))),
wherein the inspection firmware has a function of performing a different process depending on a constituent possessed by the apparatus.
   (((6)))

The information processing system according to (((1))),
wherein the inspection firmware has a function of performing a different process depending on whether the apparatus possesses a specific constituent.
   (((7)))

A program causing a computer to execute a process, the process comprising:
if a malfunction occurs in an apparatus, transmitting to the apparatus inspection firmware for collecting a log for investigating the malfunction and causing the apparatus to update firmware possessed by the apparatus to the inspection firmware.

What is claimed is:

1. An information processing system comprising:
a processor configured to:
if a malfunction occurs in an apparatus, transmit, to the apparatus, inspection firmware for collecting a log for investigating the malfunction and cause the apparatus to update firmware possessed by the apparatus to the inspection firmware.

2. The information processing system according to claim 1,
wherein the processor is configured to:
if the apparatus does not possess the inspection firmware, transmit the inspection firmware to the apparatus.

3. The information processing system according to claim 1, further comprising:
a memory configured to:
store a plurality of different pieces of inspection firmware in advance, wherein the processor is configured to:
transmit to the apparatus a piece of inspection firmware associated with the malfunction out of the plurality of different pieces of inspection firmware.

4. The information processing system according to claim 1,
wherein the processor is configured to:
if a second malfunction different from a first malfunction occurs in the apparatus, the first malfunction being associated with the inspection firmware to which the firmware possessed by the apparatus has been updated, transmit to the apparatus inspection firmware for investigating the first malfunction and the second malfunction and cause the apparatus to update firmware possessed by the apparatus.

5. The information processing system according to claim 1,
wherein the inspection firmware has a function of performing a different process depending on a constituent possessed by the apparatus.

6. The information processing system according to claim 1,
wherein the inspection firmware has a function of performing a different process depending on whether the apparatus possesses a specific constituent.

7. A non-transitory computer readable medium storing a program causing a computer to execute a process, the process comprising:
if a malfunction occurs in an apparatus, transmitting to the apparatus inspection firmware for collecting a log for investigating the malfunction and causing the apparatus to update firmware possessed by the apparatus to the inspection firmware.

8. An information processing method comprising:
if a malfunction occurs in an apparatus, transmitting to the apparatus inspection firmware for collecting a log for investigating the malfunction and causing the apparatus to update firmware possessed by the apparatus to the inspection firmware.
